(19) United States
(12) Patent Application Publication
(10) Pub. No.: US 2008/0212101 A1
(43) Pub. Date: Sep. 4, 2008

(54) Optical Sensor for Detecting Moisture on a Windshield of a Motor Vehicle

(76) Inventors: Frank Wolf, Buehl (DE); Vladislav Matusevich, Jena (DE); Manfred Tettweiler, Wilhelmshaven (DE); Richard Kowarschik, Schleiz (DE); Karim Haroud, Chavannes sur Moudon (CH); Andreas Pack, Buehl (DE)

Correspondence Address: KENYON & KENYON LLP, ONE BROADWAY, NEW YORK, NY, 10004, US

(21) Appl. No.: 11/667,510

(22) PCT Filed: Oct. 12, 2005
(86) PCT No.: PCT/EP05/55174

§ 371 Date: Oct. 29, 2007

(30) Foreign Application Priority Data
Nov. 11, 2004 (DE) 102004054465.4

(51) Int. Cl. G01N 21/55

(52) U.S. Cl. 356/445

(57) ABSTRACT

In an optical sensor for detecting moisture on a windshield of a motor vehicle, in which the light radiation is deflectable to a detection area on the windshield situated in the light path between transmitter and receiver, the transmitter and/or the receiver have a transparent design and are integrated into the windshield. The transparent optical elements may thus be situated in the area of a wiped field of the windshield cleaned by the windshield wiper.

### FIELD OF THE INVENTION

The present invention relates to an optical sensor for detecting moisture on a windshield of a motor vehicle, having a transmitter which emits radiation, a receiver, and at least one light-conducting element, the radiation being deflectable to a detection area on the windshield situated in the light path between the transmitter and the receiver.

### BACKGROUND INFORMATION

German Patent Application No. DE 102 29 239, for example, describes an optical sensor of this type. Optical sensors of this type are known in many variations and are used in motor vehicles as rain sensors, in particular for (automatic) control of windshield wiper systems. The light-conducting elements may be designed, for example, as injection couplers, retroreflectors, or as light-guiding elements, in particular waveguides.

The known sensors typically, but not exclusively, operate by the total reflection principle. This detection method predominantly used in today's rain sensors depends first on light being able, as known, to propagate in a waveguide by total reflection, since the reflection medium, i.e., the jacket or surroundings of the waveguide, has a lower refraction index than the waveguide core. The boundary surfaces, i.e., the sides of the windshield, initially fully reflect the light introduced into the waveguide at a sufficiently large angle (>42°) with the aid of a coupler, for example, a prism, since the light beam angle in the case of a dry boundary surface is sufficiently large to prevent a split into a reflecting and a transmitting light beam. If a raindrop wets the light channel, a boundary angle increased from 42° to 60° applies to the modified media transition (from glass/air to glass/water), so that a large portion of the light introduced at an angle between 42° and 60° with regard to the rain sensor function now exits via this droplet. The light conductivity of the channel, which diminishes as a function of the moisture, is measured at the extraction point (again a prism or the like) with the aid of photodiodes or phototransistors.

Instead of analyzing the decline of a defined basic signal as a useful signal as in the detection principle based on total reflection, it is also possible to use the scattered or reflected radiation when the light is directed at the droplet as the useful signal for detecting moisture on a windshield. Total reflection and scattered beam detection may also be combined. For example, German Patent Application No. DE 43 29 188 describes a sensor in which the light propagates by total reflection in the windshield. When the windshield is wetted, part of the light exits the windshield; however, it is scattered back on the droplet and exits toward the inside of the windshield, where it may be utilized by a receiver.

Many of the known rain sensors use the automobile windshield itself or a detection area of the windshield often extending only over a few centimeters, whose wetting by raindrops or other moisture droplets is to be detected, as a waveguide. The light emitted by a transmitter is injected into the windshield from the inside of the windshield and extracted again using appropriate coupling means, for example, prisms or holographic coupling foils. Since the non-transparent parts of the rain sensor (transmitter/receiver, housing, analysis electronics) should not interfere with the field of view of the driver, but the detection area of the sensor should be mounted in an area of the windshield which is cleaned by the windshield wiper, sensor embodiments have also been developed in which an additional waveguide formed on or in the windshield is used for bridging the distance between the detection area and the remaining parts of the rain sensor, i.e., for bridging the areas of the windshield not cleaned by the wiper.

The above-mentioned German Patent Application No. DE 102 29 239 describes a rain sensor in which the additional waveguide is provided in an intermediate layer of a composite glass windshield. The light is extracted at a suitable point from the waveguide toward the outside of the windshield, where it is fully reflected and injected again into the waveguide located inside, so that the moisture present in the detection area on the outside of the windshield causes, as desired, a weakening of the light beam due to partial extraction, making it possible to analyze it in the known manner. It is also known that a guiding element and/or the extracting element may be designed as a hologram, which makes these light-conducting elements transparent to the driver of the motor vehicle so that they do not limit his/her field of view.

An object of the present invention is to refine the sensor defined above in such a way as to provide a larger range of variation of sensor shape or sensor structure in particular without impairing the driver's field of view.

### SUMMARY OF THE INVENTION

In the approach according to the present invention, the transmitter and/or the receiver has a transparent design and is integrated into the windshield. Due to the combination and arrangement according to the present invention of the transparent optical elements, sensors of different designs may be implemented without impairing the driver's field of view, which considerably reduces the complexity outside the windshield. The sensors according to the present invention may be used for moisture detection on the outside and/or inside of the windshield, i.e., as rain and/or condensate sensors; they are manufacturable at a low cost and with high optical precision. The transparent optical elements may be integrated in particular into the adhesive intermediate layer of a composite glass windshield. The above-described methods of total reflection and/or scattered radiation detection may be used as detection principles.

In a particularly preferred variant of this approach, the transmitter and the receiver are situated side-by-side on the windshield and a light-conducting element is designed as a collimator for deflecting the radiation from the transmitter into the receiver via the detection area. This sensor may be implemented with great variability and low cost regarding its parts situated inside or outside the windshield.

In another, particularly compact variant, the transmitter and the receiver may be designed as a transparent transmitter/receiver system and situated one on top of the other in the area of a wiper-cleaned area of the windshield, the transmitter being situated between the receiver and the side of the windshield provided for detection. At the same time, the light-conducting element is designed as a collimator for deflecting the radiation from the transmitter into the receiver via the detection area and through the transparent transmitter.

In the above-mentioned variants, either the outside or the inside of the windshield may be provided for detection. According to another advantageous variant, detection on both sides is possible in a simple way by integrating into the windshield, in addition to the first transparent optical elements (transmitter, receiver, light-conducting elements) for detecting on a first side of the windshield, also second transparent optical elements for detecting on a second, opposite side of the windshield. The first and second optical elements are designed mirror-symmetrical with respect to a plane parallel to the detection sides of the windshield.

As an alternative to the previously mentioned variants, embodiments having an additional waveguide are also possible within this approach. This first opens up the possibility that the transmitter and the receiver are either in the area or outside the area of a wiper-cleaned area of the windshield. At the same time, it is provided that the light-conducting element be on a portion of the light path between transmitter and receiver as a waveguide integrated into the windshield, and that the waveguide has an injection coupler for injecting the radiation coming from the detection area of the windshield into the waveguide.

In a refinement of this variant, it is provided that at least part of the light path between the transmitter and an extraction point at which the radiation is extracted toward the detection area and between an injection point for the radiation coming from the detection area and the receiver be designed as a waveguide, the waveguide having an extraction coupler at the extraction point and an injection coupler at the injection point. With reference to the waveguide area located “upstream” and “downstream” from the detection area, reference may be made to a “two-part” waveguide or “two” waveguides. It is also advantageous to integrate either the transmitter or the receiver into the waveguide or to inject the radiation into and extract it from the waveguide with the aid of a further light-conducting element, the further light-conducting elements being designed as collimators.

Otherwise it is not absolutely necessary to provide a waveguide “upstream” from a detection area. Instead, a further light-conducting element may be provided for deflecting the radiation directly, without a waveguide, from the transmitter to the detection area, the further light-conducting element being designed as a collimator.

In all embodiments having an additional waveguide it is advantageous if the waveguide has a glass film as a core and a jacket layer made of Teflon, and if the waveguide is situated in or on the adhesive intermediate layer of a composite glass windshield.

Of particular advantage is to provide a polymer film which is integrated in or on the adhesive intermediate layer of a composite glass windshield and to locate the transparent transmitter, or the transparent transmitter and the transparent receiver in the polymer film. The transparent optical elements may, however, also be directly integrated in or on the PVB intermediate layer or at another suitable location in the windshield.

### BRIEF DESCRIPTION OF THE DRAWINGS

FIGS. 1 through 4 show a section through the windshield of a motor vehicle with a schematic partial view of the sensor according to the present invention in several variants without additional waveguides.

FIGS. 5 through 10 show, in the same way, different variants of the sensor according to the present invention having an additional waveguide.

FIG. 11 shows a variant of the embodiments without additional waveguides.

FIG. 12 shows a variant of the embodiments having an additional waveguide.

### DETAILED DESCRIPTION

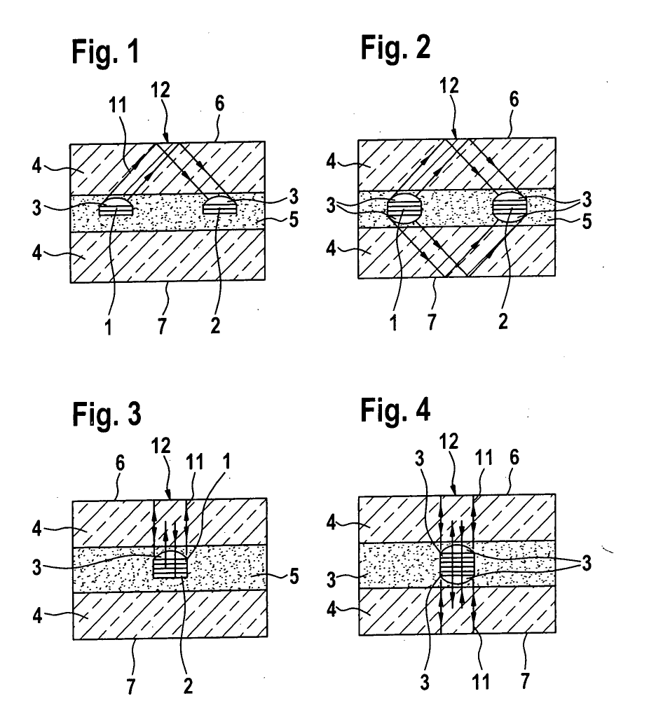

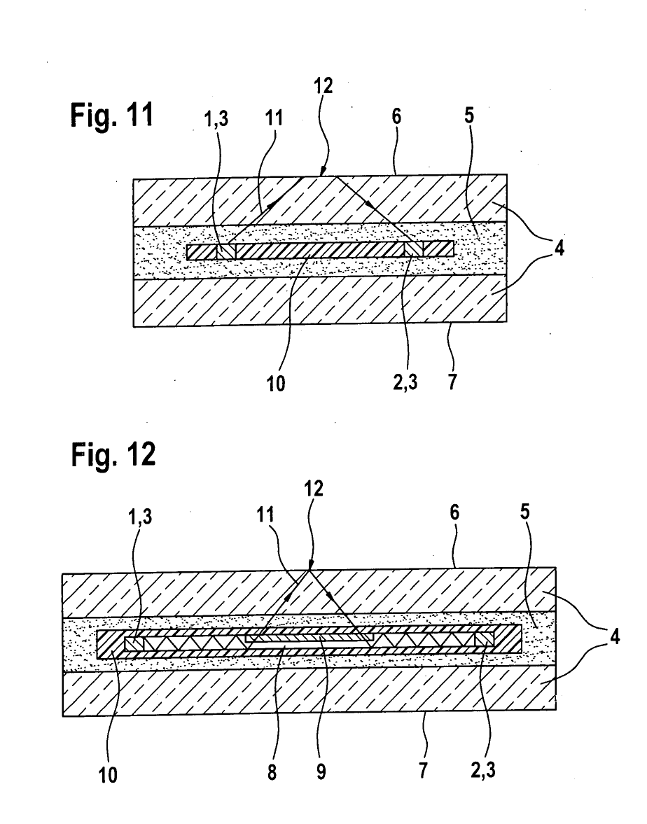

In the exemplary embodiments according to FIGS. 1 through 12, a detail of an automobile windshield, known per se, made of composite glass and having windshield parts 4 and adhesive intermediate layer 5 typically made of polyvinyl butyrate (PVB) is shown.

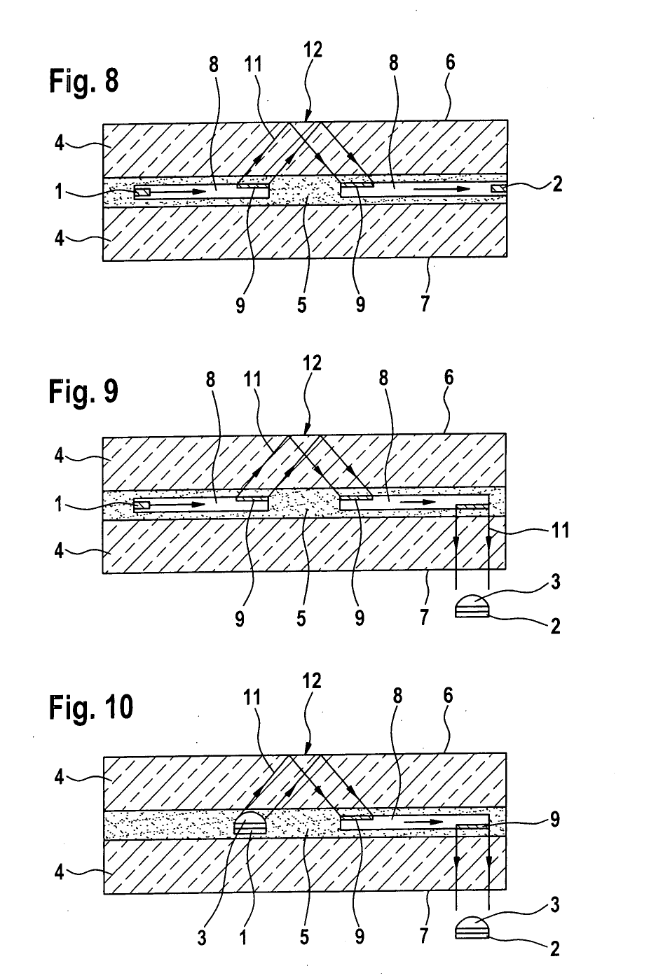

In FIG. 1, the light source, i.e., transmitter 1, and receiver 2 of the sensor have a transparent design and are integrated side-by-side in PVB layer 5. Two light-conducting elements designed as collimators 3, which are associated with transmitter 1 and receiver 2, i.e., situated in their proximity in such a way that radiation 11 is directed from transmitter 1 through windshield part 4 to detection area 12 on outside 6 of the windshield, deflected at detection area 12 and directed further, again through windshield part 4 into receiver 2, are also shown. Collimator 3 may have one or more optical elements having reflective, refractive, or diffractive properties. These elements 3 may be produced, if situated directly in PVB layer 5, using known holographic methods or, if situated on a polymer film 10, as described below in connection with FIG. 11, by mechanical structuring or by laser. This is also true for the following exemplary embodiments.

Collimator 3 modifies, i.e., deflects the wave front of radiation 11 as usual in such a way that radiation 11 is optimally detectable at detection area 12. Weakening of radiation 11 via interference by the total reflection occurring in the case of a dry boundary surface 6 or scattered radiation detection or by a combined method may be used as detection methods. Radiation 11 may also be deflected by collimator 3 and/or using other measures here as in the following exemplary embodiments in such a way that it interacts multiple times with detection area 12.

Due to their transparency, transmitter 1 and receiver 2 may be situated at any point of the windshield provided for detection area 12 without interfering with the driver's field of view. However, the sensor is not to be triggered by moisture or dirt which, under certain conditions, are typically present outside the area cleaned by the windshield wiper; therefore, detection area 12, i.e., transmitter 1 and receiver 2, may and should be situated in the field of the windshield cleaned by the windshield wiper.

Transmitter 1 and receiver 2 may be typically situated at a distance from each other of only a few millimeters. The electrical connection to the analysis electronics and the power supply is implemented using wires which are only a few micrometers thick and virtually invisible, and lead from transmitter 1 and receiver 2 to the periphery of the windshield and optionally further to other sensor parts outside the windshield. FIG. 3 shows an exemplary embodiment in which transmitter 1 and receiver 2 are situated one on top of the other as a layer structure in such a way that light beam 11, emitted by transmitter 1 and further deflected by a collimator 3, is reflected back or scattered back on boundary surface 6, passes through transparent transmitter layer 1, and is captured by transparent receiver layer 2 below. This results in a very compact sensor structure in the windshield.

In FIGS. 1 and 3, an embodiment, in which detection is not limited to a selectable side of the windshield, but is possible simultaneously on outside 6 and inside 7 of the windshield, is associated with each of FIGS. 2 and 4. A compact and easily manufacturable structure is achieved as shown by designing the first and second optical elements to be essentially mirror-symmetrical with respect to a plane parallel to the detection sides of the windshield.

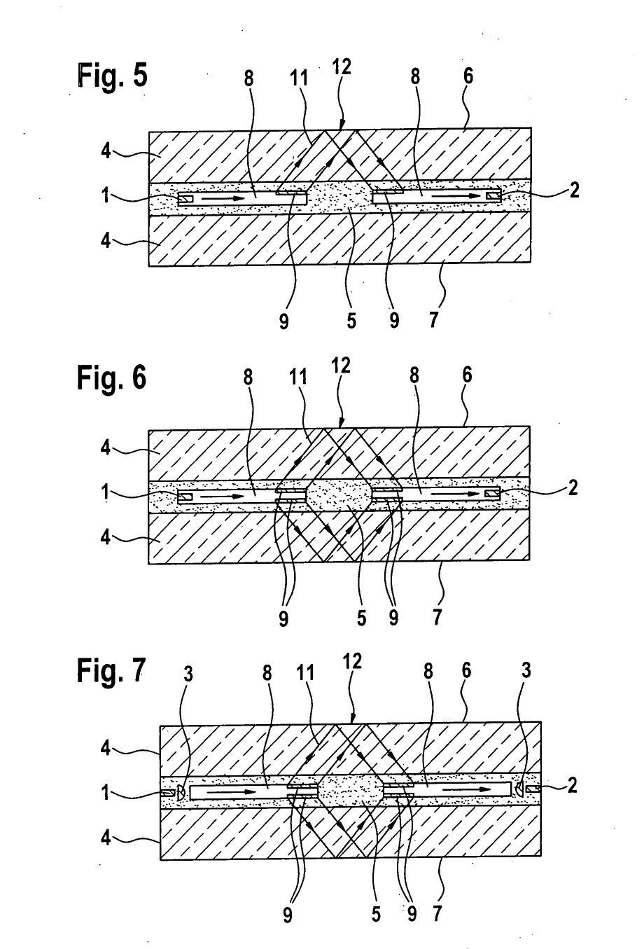

FIGS. 5 through 10 show exemplary embodiments in which radiation 11 is guided on a major portion of the light path between transmitter 1 and receiver 2 in a waveguide 8 situated in or on PVB layer 5. FIGS. 5 and 7 refer to variants in which transmitter 1 and receiver 2 are both transparent, while FIGS. 8 through 10 refer to variants having a non-transparent receiver 2. Alternatively, the receiver may also be transparent and the transmitter non-transparent. Waveguide 8 makes it possible to position the transparent transmitter/receiver 1 and 2 or only transparent transmitter 1 either in the area or outside the area of the windshield cleaned by the wiper, since ultimately only detection area 12 must be positioned in the wiped area.

As FIG. 5 shows, radiation 11 first propagates in a first portion of waveguide 8, until it is extracted toward detection area 12 at the extraction point selected with regard to the desired detection area 12 with the aid of an extraction coupler 9. On outside 6 of the windshield, light beam 11 is reflected on the glass-air boundary surface or, when outside 6 is wetted with moisture, on the glass-water boundary surface or scattered on the water droplets that may be present and thus deflected in such a way that light beam 11 then reaches the second portion of waveguide 8 which is designed at the appropriate injection point using an injection coupler 9 in such a way that radiation 11 is conducted further in the second portion of waveguide 8. Couplers 9 may be designed, for example, as holographic grids. As FIG. 6 shows, couplers 9 may also be “doubled,” in particular in the mirror-symmetrical way indicated, to make detection on both sides of the windshield possible.

As FIGS. 5 and 6 show, transmitter 1 and receiver 2 may be directly integrated into waveguide 8 or into the two waveguide portions. However, they may also be situated outside waveguide 8 (see two-sided detection according to FIG. 7), in which case a collimator 3 may be provided as shown.

FIGS. 8 through 10 show variants regarding the arrangement and design of transmitter 1 and receiver 2. According to FIG. 8, a transparent transmitter 1 may be combined with a non-transparent receiver 2, in which case the latter is to be situated on the periphery of the windshield, where it does not interfere with the driver's field of view; on the other hand, dirty edge areas of the windshield are bridged by the right-hand area of waveguide 8. Another possibility is depicted in FIG. 9 and requires another coupler 9 for extracting radiation 11 toward an external receiver 2 in the interior of the motor vehicle. Alternatively, also the transmitter may be non-transparent and the receiver transparent.

As FIG. 10 shows, even in the case of variants having transparent transmitter 1 and receiver 2, there is the possibility of providing a further light-conducting element for deflecting radiation 11 in the windshield directly, without a waveguide (portion) from transmitter 1 to detection area 12, the further light-conducting element being designed as a collimator 3.

In the variants according to FIGS. 5 through 10, waveguide 8 may advantageously have a glass film as a core and a jacket layer of Teflon and be situated in or on adhesive intermediate layer 5 of a composite glass windshield. Otherwise even in the variants of FIGS. 8 through 10 there is the possibility of extension to two-sided detection.

Direct integration of the layer-shaped transparent transmitter 1 and receiver 2 into PVB layer 5 is basically possible. However, indirect integration with the aid of a polymer film 10 which is integrated in or on adhesive intermediate layer 5 of a composite glass windshield is technically easier to implement. In this case, transparent transmitter 1, or transparent transmitter 1 and transparent receiver 2, are situated in polymer film 10. Transparent layer structures 1 and 2 may then be advantageously produced first in polymer film 10, which may be integrated into PVB layer 5 later.

1-9. (canceled)

10. An optical sensor for detecting moisture on a windshield of a motor vehicle, comprising:
a receiver; and
a transmitter for emitting light radiation to the receiver, the light radiation being deflectable, in a light path between the transmitter and the receiver, to a detection area on the windshield situated between the transmitter and the receiver, wherein at least one of the transmitter and the receiver has a transparent design and is integrated into the windshield.

11. The optical sensor according to claim 10, wherein the transmitter and the receiver are situated side-by-side, and further comprising a light-conducting element including a transparent collimator for deflecting the radiation from the transmitter to the receiver via the detection area.

12. The optical sensor according to claim 10, wherein the transmitter and the receiver are situated one on top of the other, the transmitter being situated between the receiver and the detection area of the windshield, and further comprising a light-conducting element including a transparent collimator for deflecting the light radiation from the transmitter to the receiver via the detection area and through the transparent transmitter.

13. The optical sensor according to claim 10, further comprising:
first transparent optical elements for detecting on a first side of the windshield; and
second transparent optical elements integrated into the windshield for detecting on a second, opposite side of the windshield,
wherein the first and second transparent optical elements are situated mirror-symmetrically with respect to a plane parallel to detection sides of the windshield.

14. The optical sensor according to claim 10, further comprising a waveguide integrated into the windshield and including a transparent light-conducting element on a portion of the light path between the transmitter and the receiver, the waveguide including an injection coupler for injecting the light radiation coming from the detection area of the windshield into the waveguide.

15. The optical sensor according to claim 14, wherein at least part of the light path between the transmitter and an extraction point at which the light radiation is extracted toward the detection area and between an injection point for the light radiation coming from the detection area and the receiver is designed as a waveguide, the waveguide including an extraction coupler at the extraction point and an injection coupler at the injection point, and wherein the transmitter and the receiver are integrated into the waveguide or inject and extract the light radiation into and from the waveguide with the aid of further light-conducting elements, the further light-conducting elements including transparent collimators.

16. The optical sensor according to claim 14, further comprising a further light-conducting element for deflecting the light radiation directly from the transmitter to the detection area, the further light-conducting element including a transparent collimator.

17. The optical sensor according to claim 14, wherein the waveguide has a glass film as a core and a jacket layer made of Teflon and the waveguide is situated in or on an adhesive intermediate layer of a composite glass windshield.

18. The optical sensor according to claim 10, further comprising a polymer film integrated in or on an adhesive intermediate layer of a composite glass windshield, and wherein at least one of the transparent transmitter and the transparent receiver are situated in the polymer film.
